(19) United States
(12) Patent Application Publication
(10) Pub. No.: US 2026/0326695 A1
(43) Pub. Date: Oct. 22, 2026

(54) Utility Vehicle

(71) Applicant: Kubota Corporation, Osaka-shi (JP)

(72) Inventors: Shota Watase, Sakai-shi (JP); Kazuyoshi Kawamoto, Sakai-shi (JP)

(21) Appl. No.: 19/405,656

(22) Filed: Dec. 2, 2025

(30) Foreign Application Priority Data
Apr. 18, 2025 (JP) 2025-068590

(51) Int. Cl. B60R 16/04; B60R 16/023

(52) U.S. Cl. CPC B60R 16/04; B60R 16/0239; B60Y 2200/20

(57) ABSTRACT

A utility vehicle includes a body; a body frame supporting the body; a battery; an electric power takeout section configured to supply electric power from the battery to an optional device; a support bracket fixed to the body to support the electric power takeout section; and a water preventor switchable into a first state, in which the water preventer prevents the electric power takeout section from receiving water, and a second state, in which the water preventor exposes the electric power takeout section.

### CROSS REFERENCE TO RELATED APPLICATION

This application claims priority to Japanese Patent Application No. 2025-068590 filed Apr. 18, 2025, the disclosure of which is hereby incorporated by reference in its entirety.

### BACKGROUND OF THE INVENTION

Field of the Invention

The present invention relates to a utility vehicle.

### Description of Related Art

A known utility vehicle may be configured such that an optional device such as a work light is attachable thereto as disclosed in, for example, JP 2017-047796 A. Specifically, such a utility vehicle includes an external line takeout section exposed to the outside of the vehicle body and configured to supply electric power from a battery to an optional device. The external line takeout section includes a recessed mount and a connection terminal in the recess to which an external line is connectable. The mount has an upper opening blocked by a lid fixed with use of two or more bolts. With this known configuration, the mount has an upper opening blocked by a lid fastened and fixed reliably with use of two or more bolts. This prevents the electric power takeout section (that is, the connection terminal) from receiving rain water or the like. The above configuration, however, requires a person to remove the bolts and open the lid to attach an optional device for supply of electric power. This is troublesome work. The present invention has an object of providing a utility vehicle that prevents its electric power takeout section from receiving rain water or the like and that involves no troublesome work for supply of electric power to an optional device.

With this known configuration, the lid prevents the electric power takeout section (that is, the connection terminal) from receiving rain water or the like. The above configuration, however, requires a person to remove the bolts and open the lid to attach an optional device for supply of electric power. This is troublesome work.

### SUMMARY OF THE INVENTION

The present invention has an object of providing a utility vehicle that prevents its electric power takeout section from receiving rain water or the like and that involves no troublesome work for supply of electric power to an optional device.

A utility vehicle according to the present invention includes:
a body;
a body frame supporting the body;
a battery;
an electric power takeout section configured to supply electric power from the battery to an optional device;
a support bracket fixed to the body to support the electric power takeout section; and
a water preventor switchable into a first state, in which the water preventer prevents the electric power takeout section from receiving water, and a second state, in which the water preventor exposes the electric power takeout section.

The above configuration allows the body frame to support the electric power takeout section stably. When the battery supplies no electric power to an optional device, switching the water preventer into the first state prevents the electric power takeout section from receiving water as well as mud and dust. When the battery does supply electric power to an optional device, switching the water preventer into the second state allows a person to connect an electric cable or the like to the electric power takeout section for appropriate supply of electric power. As described above, the water preventer prevents the electric power takeout section from receiving rain water or the like and is switchable in state for an optional device to be attached for supply of electric power. This eliminates troublesome work and allows a person to easily take action.

As an embodiment of the present invention, the utility vehicle may be further configured such that
the support bracket includes a flat surface covering the electric power takeout section from above, and
the water preventer extends from the flat section.

The support bracket is fixed to the body frame to support the electric power takeout section. The above configuration utilizes the support bracket to appropriately prevent the electric power takeout section from receiving rain water or the like from above.

As an embodiment of the present invention, the utility vehicle may be further configured such that
the water preventer is made of a soft, bendable material, and the water preventer hangs down in the first state and is capable of being rolled up manually into the second state.

The above configuration allows the water preventer to hang down freely to effectively prevent the electric power takeout section from receiving rain water or the like when no optional device is used and to be easily rolled up manually when the battery supplies electric power to an optional device. This eliminates troublesome work and allows a person to easily take action.

As an embodiment of the present invention, the utility vehicle may be further configured such that the water preventer is made of an insulator.

With the above configuration, the water preventer is made of an insulator. This easily prevents electricity from being conducted to another component such as the body frame in the event of contact with an electric cable.

As an embodiment of the present invention, the utility vehicle may further include:
a seat capable of accommodating an occupant,
wherein the battery is below the seat, and
the electric power takeout section is rearward of the seat.

With the above configuration, the battery is close to the electric power takeout section. This allows use of a short and simple electric cable between the battery and the electric power takeout section.

As an embodiment of the present invention, the utility vehicle may further include:
a motor section lateral to the electric power takeout section; and
a heat barrier extending from the support bracket and configured to block heat from being transferred from the motor section to the electric power takeout section,

With the above configuration, the heat barrier prevents heat generated by the motor section from being transferred to the electric power takeout section.

As an embodiment of the present invention, the utility vehicle may further include: a travel wheel rearward of the electric power takeout section relative to the body.

With the above configuration, the water preventer prevents the electric power takeout section from receiving mud or the like splashed by the travel wheel as the utility vehicle travels.

The above-mentioned and other embodiments, procedures, features, and effects of the present invention will be more apparent from the following detailed description of the embodiments with reference to the drawings.

### BRIEF DESCRIPTION OF THE DRAWINGS

FIG. 1 is a side view of a utility vehicle.

FIG. 2 is a side view of a portion of a utility vehicle to which an electric power takeout section is attached.

FIG. 3 is a rear view of a portion of a utility vehicle to which an electric power takeout section is attached.

### DESCRIPTION OF THE INVENTION

The description below deals with a utility vehicle as an embodiment of the present invention with reference to drawings. The present invention is, however, not limited to the embodiment below, and may be altered variously within its scope.

Unless otherwise specified, the description below uses terms such as “front” to refer to the direction indicated with arrow FW in the drawings, terms such as “rear” to refer to the direction indicated with arrow BK in the drawings, terms such as “left” to refer to the direction indicated with arrow LH in the drawings, terms such as “right” to refer to the direction indicated with arrow RH in the drawings, terms such as “upward” to refer to the direction indicated with arrow UP in the drawings, and terms such as “downward” to refer to the direction indicated with arrow DW in the drawings.

### Overall Configuration

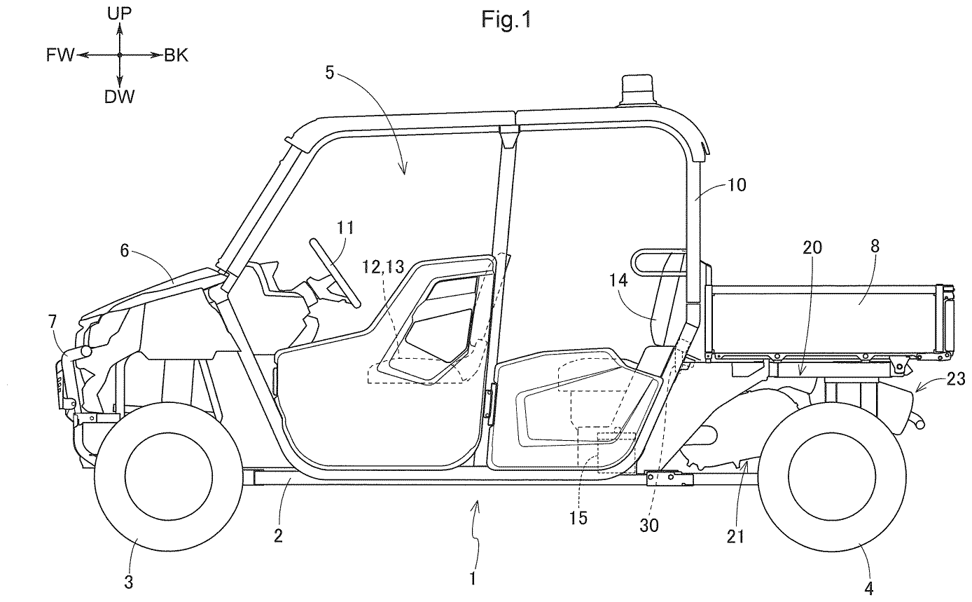

FIG. 1 illustrates a utility vehicle including a body 1, a pair of left and right body frame members 2 as a lower layer of the body 1, a pair of left and right front wheels 3 held by respective front portions of the body frame members 2, and a pair of left and right rear wheels 4 held by respective rear portions of the body frame members 2.

The utility vehicle includes a driver section 5, a front lid 6, a front bumper 7 forward of the front lid 6, and a cargo bed 8 rearward of the driver section 5. The driver section 5 is disposed in the body 1 and between the front wheels 3 and the rear wheels 4 and configured to accommodate occupants. The front lid 6 is disposed at a front portion of the driver section 5 and covering the respective front portions of the body frame members 2 from above.

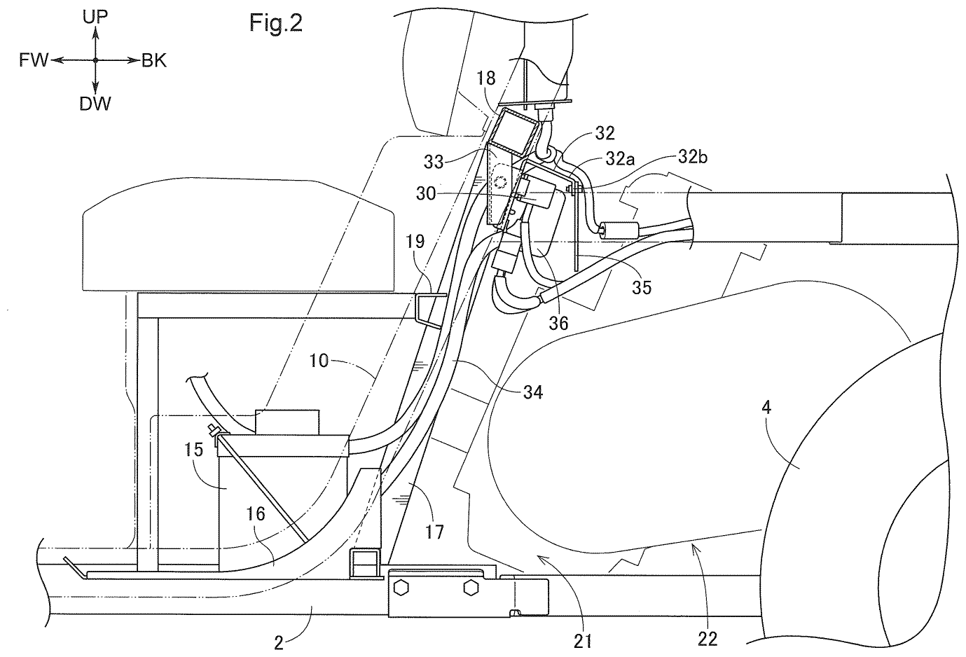

The utility vehicle includes a motor section 20 below the cargo bed 8. The motor section 20 includes an engine 21 (see FIG. 2), a belt-type continuously variable transmission device 22, and a transmission (not illustrated in the drawings). The continuously variable transmission device 22 is configured to receive motive power from the engine 21 and adjust the motive power steplessly. The transmission is configured to receive motive power from the continuously variable transmission device 22, adjust the motive power with use of gears, and transmit the resulting motive power to the front wheels 3 and the rear wheels 4. The continuously variable transmission device 22 is coupled to respective lateral portions of the engine 21 and the transmission. The transmission is rearward of the engine 21. The motor section 20 also includes a muffler and an exhaust pipe 23 configured to guide and discharge exhaust gas from the engine 21. The exhaust pipe 23 extends through a position lateral to the engine 21 to rearward of the body 1.

### Driver Section

The driver section 5 includes a roll-over protective structure (ROPS) frame 10 configured to protect occupants in the event of a roll-over accident of the utility vehicle. The ROPS frame 10 includes a pair of left and right bars so bent as to extend from a front portion of the driver section 5 to a rear portion thereof.

The driver section 5 also includes a steering wheel 11 for turning the front wheels 3 and a driver's seat 12 configured to accommodate an occupant who operates the steering wheel 11. The driver's seat 12 is at a front portion of the driver section 5. The driver section 5 includes an auxiliary occupant seat 13 and a rear occupant seat 14 (seat). The auxiliary occupant seat 13 is disposed to the right of and next to the driver's seat 12 and configured to accommodate an occupant. The rear occupant seat 14 is rearward of the driver's seat 12 and the auxiliary occupant seat 13 and configured to accommodate occupants.

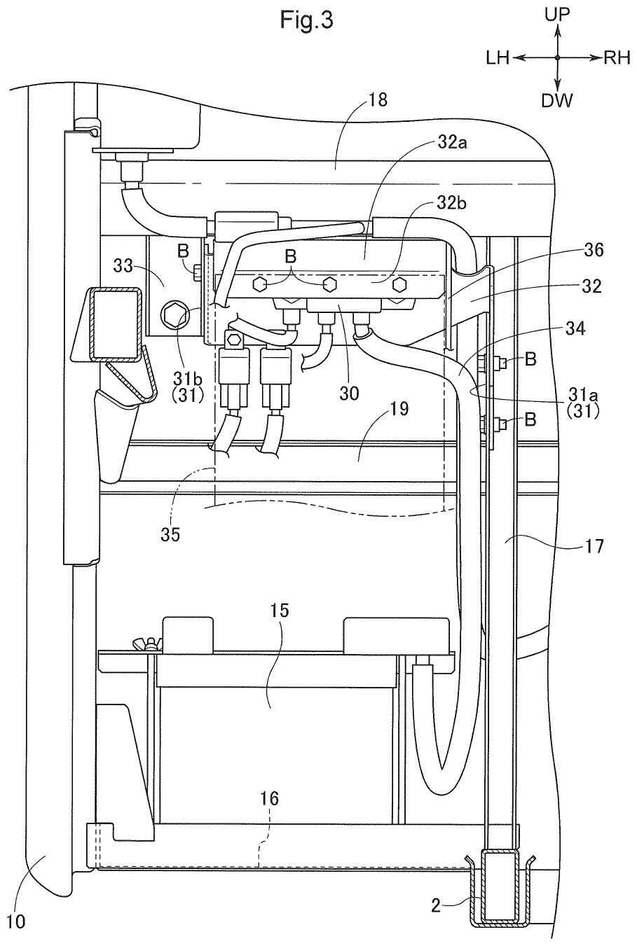

As illustrated in FIGS. 2 and 3, the driver section 5 for the present embodiment includes a battery 15 and a support base 16. The battery 15 is disposed below the rear occupant seat 14 and placed on, fixed to, and supported by the support base 16. As illustrated in FIG. 3, the support base 16 has a side inward relative to the body 1 which side is supported by the left body frame member 2, meaning that the battery 15 is supported by the left body frame member 2. The support base 16 has a side outward relative to the body 1 which side is supported by a lower portion of the ROPS frame 10.

The driver section 5 includes a vertical frame member 17 extending vertically and supported by the left body frame member 2. The vertical frame member 17 is in the form of a channel member with a cross section in the shape of a substantial C. The driver section 5 includes another vertical frame member 17 (not illustrated in the drawings) extending vertically and supported by the right body frame member 2.

The driver section 5 includes a lateral frame member 18 supported by respective upper ends of the left and right vertical frame members 17 and supporting a rear portion of the rear occupant seat 14. The driver section 5 includes an intermediate frame member 19 held by a vertically intermediate portion of the left vertical frame member 17 and extending outward relative to the body 1. The driver section 5 includes another intermediate frame member 19 (not illustrated in the drawings) held by a vertically intermediate portion of the right vertical frame member 17 and extending outward relative to the body 1. The intermediate frame members 19 each have an end outward relative to the body 1 which end is coupled to the ROPS frame 10.

### How to Attach Optional Devices and Members

As illustrated in FIGS. 2 and 3, the battery 15 supplies electric power to an optional device (not illustrated in the drawings) such as a work light capable of being retrofitted to the body 1. The utility vehicle includes in the body 1 an electric power takeout section 30, an attachment unit 31, and a support bracket 32. The electric power takeout section 30 is configured to conduct electric current from the battery 15 to an optional device and detachably attachable to the attachment unit 31 with the support bracket 32 in-between.

The attachment unit 31 includes an inner attachment section 31a and an outer attachment section 31b. The inner attachment section 31a holds a side of the support bracket 32 which side is inward (that is, on the right) relative to the body 1. The outer attachment section 31b holds a side of the support bracket 32 which side is outward (that is, on the left) relative to the body 1.

The inner attachment section 31a is at an upper portion of the corresponding vertical frame member 17 and has a bolt hole in the vertical frame member 17. The vertical frame members 17 each have a cross section in the shape of a substantial C open rearward. The support bracket 32 has a portion inward relative to the body 1 which portion is capable of coming into contact with the inner surface of the substantially C-shaped vertical frame member 17 for attachment.

The utility vehicle includes a support 33 extending downward from a portion of the lateral frame member 18 which portion is to the left of the support bracket 32. The outer attachment section 31b is on the support 33 and has a bolt hole in the support 33. The support bracket 32 has a portion outward relative to the body 1 which portion is capable of coming into contact with that surface of the support 33 which is inward relative to the body 1 for attachment.

The inner and outer attachment sections 31a and 31b are rearward of the rear occupant seat 14. The electric power takeout section 30 as attached to the attachment unit 31 is above the battery 15.

The support bracket 32 has a bolt hole on the left (that is, outward relative to the body 1) and another bolt hole on the right (that is, inward relative to the body 1). The support bracket 32 is fastened to the inner and outer attachment sections 31a and 31b with use of two bolts B through the respective bolt holes in the support bracket 32 and the respective bolt holes in the inner and outer attachment sections 31a and 31b. The support bracket 32 includes a flat section 32a extending rearward from the upper end of the support bracket 32 and covering from above the electric power takeout section 30 as attached.

Attaching the support bracket 32 to the attachment unit 31 and electrically connecting the electric power takeout section 30 to the battery 15 with use of a harness 34 or the like allows the electric power takeout section 30 to be used to supply electric power from the battery 15 to an optional device (not illustrated in the drawings).

The utility vehicle includes a water preventer 35 and a heat barrier 36. The water preventer 35 is switchable into a first state, in which the water preventer 35 prevents the electric power takeout section 30 from receiving water, and a second state, in which the water preventer 35 exposes the electric power takeout section 30. The heat barrier 36 blocks heat from being transferred from the motor section 20 to the electric power takeout section 30.

As illustrated in FIGS. 2 and 3, the water preventer 35 extends from the flat section 32a of the support bracket 32. The water preventer 35 is in the form of a soft, bendable plate made of rubber (insulator). The water preventer 35 hangs down in the first state and is capable of being rolled up manually into the second state.

The support bracket 32 includes a vertical face section 32b integral with the flat section 32a and extending downward from the front end of the flat section 32a. The water preventer 35 has an upper portion fastened to the vertical face section 32b with use of two or more bolts B. The water preventer 35 is normally in the first state, that is, hangs down to prevent the electric power takeout section 30 from receiving water from forward.

With the water preventer 35 in the first state, the flat section 32a and the water preventer 35 prevent the electric power takeout section 30 from receiving rain water, earth, sand, or the like entering the utility vehicle through a gap between the driver section 5 and the cargo bed 8. The utility vehicle includes rear wheels 4 as travel wheels rearward of the electric power takeout section 30 relative to the body 1. The rear wheels 4 may splash mud or the like as the utility vehicle travels. The water preventer 35 prevents the electric power takeout section 30 from receiving such mud or the like.

The water preventer 35, which is in the form of a rubber plate, is capable of being rolled up manually by a worker into the second state, that is, to expose the electric power takeout section 30. The second state allows the worker to connect a harness 34 to the electric power takeout section 30 for electric connection between the electric power takeout section 30 and the battery 15 and between the electric power takeout section 30 and an optional device.

The heat barrier 36 is integral with the support bracket 32. As illustrated in FIGS. 2 and 3, the heat barrier 36 is in the form of a vertical plate having faces each facing laterally and blocking the electric power takeout section 30 from the motor section 20. The heat barrier 36 prevents the electric power takeout section 30 from directly receiving heat from a hot portion of the motor section 20 such as an exhaust pipe through which exhaust gas from the engine 21 passes.

### Alternative Embodiments

The present invention is not limited to the above embodiment as an example. The description below deals with embodiments of the present invention as other typical examples.
(1) The embodiment described above is configured such that the water preventer 35 is made of a soft, bendable material and that the water preventer 35 hangs down in the first state and is capable of being rolled up manually into the second state. The embodiment may be altered such that, for instance, the water preventer 35 is made of a hard material and supported by a support bracket in such a manner as to be swingable about a lateral axis or a vertical axis to be switched between the first and second states. The embodiment may also be altered such that the water preventer 35 is slidable to be switched between the first and second states.
(2) The embodiment described above is configured such that the water preventer 35 is made of an insulator. The present invention is, however, not limited to such a configuration, and may be configured such that the water preventer 35 is made of an electrically conductive material.
(3) The embodiment described above is configured such that the battery 15 is below the rear occupant seat 14 (seat) and that the electric power takeout section 30 is rearward of the rear occupant seat 14. The embodiment may be altered such that the battery 15 is somewhere other than below the rear occupant seat 14 and that the electric power takeout section 30 is somewhere other than rearward of the rear occupant seat 14.
(4) The embodiment described above is configured such that the heat barrier 36 is integral with the support bracket 32. The heat barrier 36 may alternatively be separate from the support bracket 32. The utility vehicle may exclude such a heat barrier 36.
(5) The utility vehicle as the embodiment described above includes travel wheels (rear wheels 4) rearward of the electric power takeout section 30 relative to the body 1. The travel wheels (rear wheels 4) may not be located rearward of the electric power takeout section 30 relative to the body 1
(6) The embodiment described above is configured such that the support bracket 32 includes a flat section 32a covering the electric power takeout section 30 from above. The support bracket 32 may exclude such a flat section 32a.
(7) The embodiment described above is configured such that the water preventer 35 extends from the support bracket 32 (specifically, the flat section 32a). The embodiment may be altered such that the water preventer 35 is supported by a portion of the left body frame member 2 and extends from that portion.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present invention is not limited to those embodiments, and may be altered as appropriate, as long as such an alteration does not result in a failure to attain an object of the present invention.

The present invention is applicable to any utility vehicle including an electric power takeout section.

What is claimed is:

1. A utility vehicle, comprising:
a body;
a body frame supporting the body;
a battery;
an electric power takeout section configured to supply electric power from the battery to an optional device;
a support bracket fixed to the body to support the electric power takeout section; and
a water preventor switchable into a first state, wherein the water preventer prevents the electric power takeout section from receiving water, and a second state, wherein the water preventor exposes the electric power takeout section.

2. The utility vehicle according to claim 1, wherein:
the support bracket comprises a flat section covering the electric power takeout section from above, and
the water preventer extends from the flat section.

3. The utility vehicle according to claim 2, wherein:
the water preventer is made of a soft, bendable material, and
the water preventer hangs down in the first state and is capable of being rolled up manually into the second state.

4. The utility vehicle according to claim 1, wherein:
the water preventer is made of an insulator.

5. The utility vehicle according to claim 1, further comprising:
a seat capable of accommodating an occupant,
wherein the battery is below the seat, and
wherein the electric power takeout section is rearward of the seat.

6. The utility vehicle according to claim 1, further comprising:
a motor section lateral to the electric power takeout section; and
a heat barrier extending from the support bracket and configured to block heat from being transferred from the motor section to the electric power takeout section.

7. The utility vehicle according to claim 1, further comprising:
a travel wheel rearward of the electric power takeout section relative to the body.
